(19) United States
(12) Patent Application Publication
(10) Pub. No.: US 2008/0202437 A1
(43) Pub. Date: Aug. 28, 2008

(54) Unique Grill Pan With Auto Chick Grill For Chick Feeding

(76) Inventor: Harish Rajaram Garware, Maharashtra (IN)

Correspondence Address: BROOKS KUSHMAN P.C., 1000 TOWN CENTER, TWENTY-SECOND FLOOR, SOUTHFIELD, MI, 48075, US

(21) Appl. No.: 11/915,458

(22) PCT Filed: Aug. 10, 2005
(86) PCT No.: PCT/IN05/00272

§ 371 Date: Nov. 26, 2007

(30) Foreign Application Priority Data
May 24, 2005 (IN) 617/MUM/2005

(51) Int. Cl. A01K 39/012

(52) U.S. Cl. 119/57.4

(57) ABSTRACT

A unique feed pan with auto chick grill for feeding the broiler birds from day one without entering into the pan. It also protects the broiler birds from the effect of heavy mortality, which adversely affect the growth of chicks. It is the most efficient way of feeding to birds from day one with minimum feed wastage and to protect day old chicks from infection.

The present invention relates to feed pan with auto chick grill. More particularly, it relates to a feed pan to be used for feeding broiler birds, which shall cover chicks to fully grown-up birds.

It is directed towards providing a grill pan for broiler birds to have feed, conveniently and to have optimum ease in order to avoid the deterioration in the quality of feed. The chicks themselves could cause the deterioration in the quality of feed, by sitting and sleeping on it.

The main object of the invention is to provide the most efficient way for feeding birds from day one and to give the user an opportunity to increase his profit. It aims at minimum wastage of feed and protecting day old chicks from infection.

The unique feature of the invention is that it could feed the broiler birds from day one without entering in to the pan. It also protects the broiler birds from the effect of heavy mortality, which adversely affect the growth of chicks.

The purpose of the present invention is to control the feed wastage and thereby saving money for the farmers or the users. It also ensures the farmers or the users to increase their profits by avoiding feed wastage.

The scope of the present invention is that it eliminates the chances of litter mixing with fresh feed and therefore the chances of infection are reduced. It also minimises the chances of toxicity, which may be caused due to litter mixing with the feed.

### PRIOR ART

In the prior art there is no such feed pan available which could feed the broiler birds from day one, without making the broiler birds to enter into the pan. In the old and conventional pan design, broilers at chick stage, say day old stage to 5-6th day, cannot eat the feed from day one without entering into the pan. In cases, wherein the chicks/broiler birds are unable to enter into the pan are fed in a separate chick tray. Even though the broiler birds/chicks are fed in a separate chick tray, they are unable to reach to the feed without entering into it.

In the conventional pan design as stated above, the broiler chick (1-5 days old) has to enter into the pan or into the tray to have feed, which is fresh and is of good quality. The chicks' spoils the quality of the feed placed inside the tray or pan by sitting and sleeping on it. The chicks also have a tendency to scoop away the feed by their feet and hence the feed falls outside the pan or tray into the littered floor and thereby results in wastage of feed. This waste of costly feed adversely affects the feed conversion ratio (FCR) and accordingly the broiler production cost increases. This spoiled littered feed is consumed by the chicks instead of having fresh feed and thereby suffer from infection, which further adversely affects the growth of chicks or sometimes results to heavy mortality. Thus the old or conventional pan may lead to heavy loss to the user.

### Drawbacks of Prior Art:

1. The broilers at chick stage cannot eat the feed from day one without entering into the pan.
2. A separate tray is required to feed the chicks if the chicks are unable to enter into the pan. It is also difficult to feed chicks in tray, as at chick stage they cannot reach to the feed without entering into it.
3. The quality of feed gets affected adversely as the chicks themselves spoil it.
4. The amount of wastage is very high as the chicks have a tendency to scoop away the feed by their feet which further affects the feed conversion ration adversely and accordingly cost of production increases.
5. The chicks consume spoiled feed, which causes infection and further affects the growth of chicks and sometimes results to heavy mortality.
6. The old or conventional pan leads to heavy loss to the user.

### Present Invention:

With a view to overcome the deficiencies found in the prior art, the present invention is introduced. According to the present invention, a feed pan with auto chick grill is a specially designed assembly of numerous plastic moulded parts. These assemblies are attached at a distance of 600 mM to 1500 mM to the pipes having a centre less screw. The screw conveys the feed all along the pipe to refill the feed in these pans. The pan has unique moving grill which restricts the day old chicks from entering the pan but allows the chick to eat the feed from outside the pan. As the birds grow the pan with pipeline is lifted to bird's convenient feeding position. As the pan is lifted, this unique grill also moves proportionately on the inner side to make more feeding space for the grown up birds, still restricts them from entering the pan. As the pan is further lifted to convenient feeding height of the fully-grown large bids, this moving grill also shifts totally on the inner side to provide them sufficient feeding space. Hence, due to this moving grill the chicks cannot waste and spoil any feed during the entire rearing cycle, which is one of the major and most expensive inputs in poultry farming.

Therefore according to the present invention a novel feed pan with auto chick grill for chick feeding comprises of a grill ring, which is fixed to the collar of the grill; a feed outlet is inserted into the grill and the disc is placed on the top of the grill through the feed outlet; a slide feed stopper is a shutter which is fixed in the slot provided on to the top of the feed outlet; a feed leveller is attached to the ring whereas a rib is fixed on the ring; this assembly of feed leveller and ring is inserted in the feed outlet; a grill is horizontally inserted through the ring and is twisted to fix the same in the ring slot and its stand; a rod is inserted in the pan from the bottom and is pushed hard to click fit the rod in the pan; a pillar is inserted in the rod from the top whereas the lower head of the inner pillar is click fitted in the slots of the bottom support ring; a ring is inserted in the inner pillar and in the rod, which is pushed to fit the pan in the grill and thus the pan is ready for installation on the pipe; this pipe conveys feed to every feed pan with the help of spiral wire or auger, wherein the lips of the pipe are inserted in the slots of inner cylinder and then slide the cap to fix the complete assembly on the pipe so that it holds the pipe and feed pan at the same time; the cap is also used to fix anti perch wire which prevents birds from perching/sitting on the feed line.

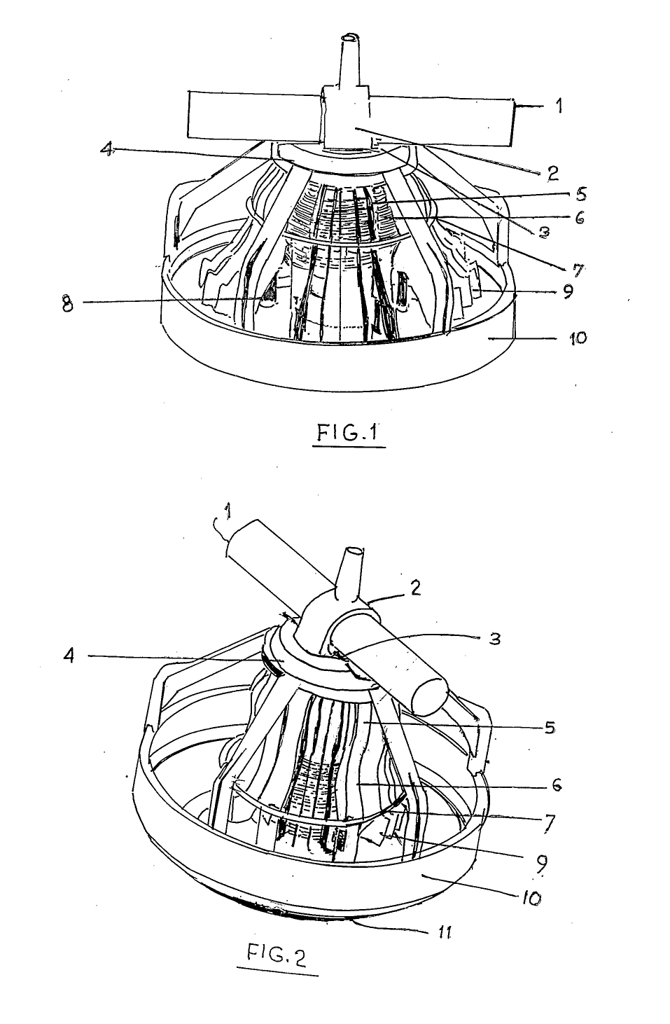

The invention will now be described with the help of accompanying drawings FIG. 1 and FIG. 2 wherein FIG. 1 shows the construction of the pan and also the position of a feed pan with a fully open grill for chick feeding. FIG. 2 shows the position of feed pan out of the grill.

The feed pan with auto chick grill is a specially designed assembly of numerous plastic moulded parts, which are as follows:

| | | | |
|---|---|---|---|
| 1. | Pipe | 2. | Cap |
| 3. | Feed stopper | 4. | Disc |
| 5. | Feed Outlet | 6. | Feed Leveller |
| 7. | Ring | 8. | Rod |
| 9. | Rib | 10. | Grill |
| 11. | Pan | | |

FIG. 1 shows the construction as well as position of a feed pan with a fully open grill for chick feeding.

The Grill ring (7), which works as support or stand of the feed pan is fixed in the collar of the grill (10) to guide/direct the chick grill wile changing the position of the pan. While doing so, it is ensured that the elevated part of the ring faces the grill and fits in 5 notches of the grill. The grill (10) is provided to prevent big birds from entering the pan. Importantly, it allows the birds to eat the feed but prevents them from vesting it. The feed outlet (5) is inserted into the grill (10) to maintain the level of the feed during various stages of the growth of bird. It also holds the grill of the feed pan. The disc (4) to guide shut off and help in smooth operation of the pan is placed on the top of the grill through the feed outlet (5). Slide feed stopper (3) is a shutter which controls the flow of the feed, supplied by the G.I. Pipe (1) and is fixed in the slot provided on the top of the feed outlet. Whenever required necessary feed supply can be stopped with the help of slide feed stopper. The G.I pipe conveys feed to every feed pan with the help of spiral duly provided. The feed leveller (6) is screwed in the ring (7) to guide the ring stand and maintain the level of the inner cylinder. A rib (9) is fixed on the ring, which is further fixed to the grill. The chick grill acts as grill for chicks, which allows required feed access to chicks/growing birds according to the age and size of birds. The assembly of feed leveller (6) and the ring (7) is assembled in the feed outlet (5). The grill (10) is horizontally inserted through the ring (7) and is twisted to fix the same in the slot of ring. While doing so, it is ensured that the grill is always fixed on the second slot from the arm end of the grill. The rod (8) is inserted in the pan (11) from the bottom and is pushed hard to click fit the rod in the pan to support and guide the entire feed pan and its movement during its operation. The pan is a pot, which is used to keep and distribute feed. It also acts as a base of entire feed pan when birds are in brooding stage. This pan consists of five holes wherein outer/inner pillars are installed. The pillar is inserted in the rod from the top. The lower head of the inner pillar is click fitted in the slots of the bottom support ring. The ring is inserted in the inner pillar and rod and further pushed to fit the pan in the grill. Now the pan is ready to be installed on the pipe. Insert the lips of the pipe in the slots of the inner cylinder and then slide the cap (2) to fix the complete pan assembly on the pipe. The cap is used to hold the pipe and at the same time it also holds feed pan from the upper portion. A slot is provided at the top of the cap, which is used to fix anti perch wire, which prevents birds from perching/sitting on the feeding line.

FIG. 1 also shows the position of a feed pan with a fully open grill for chick feeding. During this stage feed pan is rested on the floor. The Pan (1) goes inside and as the ring (7) is lifted up; the rib (9) comes out and covers the entire inner pan space. This prevents chicks from going in to the pan and due to less height of the grill; the chick has easy access of the feed from outside the pan.

FIG. 2 shows the position of feed pan out of the grill. At this position, the feed pipe (1) is lifted up with the help of wire rope and winching system, which enables the rib (9) to go inside so that the grown up birds have enough space to have feed.

While the invention has been described with reference to the preferred embodiments, various changes may be made and equivalents may be substituted for components thereof without departing from the scope of the invention. In addition, many modifications may be made to adopt the particular situation or materials to the teachings of the invention without departing from essential scope thereof.

Advantages of Invention:
1. Feed wastage is controlled which saves money for the farmers/user.
2. The chances of litter mixing with fresh feed is eliminated, therefore chances of infection is reduced to a large extent.
3. The chances of litter mixing with feed are not found and therefore toxicity in the chicks is minimised.
4. This invention ensures and will encourage the user/farmer to save money and gain profits by avoiding feed wastage.

1. A unique feed pan with auto chick grill for chick feeding comprising of a grill ring, which is fixed to the collar of the grill; a feed outlet is inserted into the grill and the disc is placed on the top of the grill through the feed outlet; a slide feed stopper is a shutter which is fixed in the slot provided on to the top of the feed outlet; a feed leveller is attached to the ring whereas a rib is fixed on the ring; this assembly of feed leveller and ring is inserted in the feed outlet; a grill is horizontally inserted through the ring and is twisted to fix the same in the ring slot and its stand; a rod is inserted in the pan from the bottom and is pushed hard to click fit the rod in the pan; a pillar is inserted in the rod from the top whereas the lower head of the inner pillar is click fitted in the slots of the bottom support ring; a ring is inserted in the inner pillar and in the rod, which is pushed to fit the pan in the grill and thus the pan is ready for installation on the pipe; this pipe conveys feed to every feed pan with the help of spiral wire or auger, wherein the lips of the pipe are inserted in the slots of inner cylinder and then slide the cap to fix the complete assembly on the pipe so that it holds the pipe and feed pan at the same time; the cap is also used to fix anti perch wire which prevents birds from perching/sitting on the feed line.
